(19) United States
(12) Patent Application Publication
(10) Pub. No.: US 2026/0323207 A1
(43) Pub. Date: Oct. 15, 2026

(54) ARCH SOUND BAR

(71) Applicants: Michael Shedivy, Elkhart, IN (US); Victor B. Garcia, Granger, IN (US)

(72) Inventors: Michael Shedivy, Elkhart, IN (US); Victor B. Garcia, Granger, IN (US)

(21) Appl. No.: 19/644,777

(22) Filed: Apr. 10, 2026

Related U.S. Application Data
(60) Provisional application No. 63/787,524, filed on Apr. 11, 2025.

(51) Int. Cl. H04R 1/40; B60R 11/00; B60R 11/02; B63B 17/02; H04R 1/02; H04R 1/06; H04R 3/12

(52) U.S. Cl. CPC H04R 1/403; B60R 11/0217; B63B 17/02; H04R 1/026; H04R 1/06; H04R 3/12; B60R 2011/0045; H04R 2499/13

(57) ABSTRACT

A boat comprises a boat frame including a boat deck, an arch coupled to the boat frame, a first speaker, and a second speaker. The arch includes a first socket and a second socket. The first speaker is installed in the first socket. The first speaker in the first socket is directed to a first area associated with the boat. The first speaker is configured to provide directional audio to the first area. The second speaker is installed in the second socket. The second speaker in the second socket is directed to a second area associated with the boat. The second speaker is configured to provide directional audio to the second area.

### PRIORITY APPLICATIONS

This application claims the benefit of priority to U.S. Provisional Patent Application Ser. No. 63/787,524, filed Apr. 11, 2025, the content of which is incorporated herein by reference in its entirety.

### TECHNICAL FIELD

This document pertains generally, but not by way of limitation, to a boat, an audio system on the boat, and more particularly, to an integrated speaker in an arch of the boat.

### BACKGROUND

Boats are used for recreational activities, such as family outings, fishing, water sports, and relaxing on the water. Some boats, such as pontoon boats, provide a large deck area with seating in different areas of the boat, according to various examples. In various examples, passengers gather in the different areas of the boat.

### BRIEF DESCRIPTION OF THE DRAWINGS

The appended drawings illustrate example embodiments of the present disclosure and should not be considered as limiting its scope.

FIG. 1 is a top view of an example of a boat.

FIG. 2A is a perspective view of an example of portions of an arch with one or more integrated speakers.

FIG. 2B is a perspective view of portions of the arch of FIG. 2A.

FIG. 3 is a top view of another example of a boat, including a plurality of audio zones facilitated by an integrated speaker system within an arch.

FIG. 4 is a top view of another example of a boat, including an example of a pre-configured audio setting of a passenger zone facilitated by an integrated speaker system within an arch.

FIG. 5 is a top view of another example of a boat, including an example pre-configured audio setting of a surround sound zone facilitated by an integrated speaker system within an arch.

FIG. 6 is a top view of another example of a boat, including an example pre-configured audio setting of a party zone facilitated by an integrated speaker system within an arch.

FIG. 7 is an example user interface including example portions for configuring an audio setting.

FIG. 8 is a block diagram illustrating an example of a machine upon which one or more examples are implemented.

### DETAILED DESCRIPTION

In examples, a boat is equipped with an audio system. In various examples, the audio system includes one or more speakers. For instance, in various examples, the boat includes a speaker housed within a seating area, an underlying seating area, or in a console of the boat. In some examples, marine audio systems include large, cumbersome speakers mounted to the boat, which obstruct access to the boat, limit audio directionality, or inefficiently use the boat's space. The present disclosure addresses these challenges by integrating a speaker directly into an arch of the boat, according to some examples. In examples, by integrating the speaker into the arch of the boat, directional audio is pinpointed to one or more specific locations, space usage is optimized, audio control is improved, and the design integrity of the boat is maintained. In examples, the integrated system simplifies installation and offers adaptability for one or more different types of arches, thereby providing a seamless and immersive audio experience for marine applications.

In examples, the boat includes a boat frame, which includes a boat deck. In some examples, an arch is coupled (e.g., mounted, attached, connected, installed, fixed, bolted, welded, or the like) to the boat frame. The arch includes a first socket and a second socket. A first speaker is installed in the first socket. The first speaker in the first socket is directed to a first area associated with the boat. The first speaker is configured to provide directional audio to the first area. A second speaker is installed in the second socket. The second speaker in the second socket is directed to a second area associated with the boat. The second speaker is configured to provide directional audio to the second area.

In some examples, an arch for a boat includes a first end portion configured for coupling with a boat frame and a second end portion configured for coupling with the boat frame. An arch member extends between the first end portion and the second end portion having an arch profile. The arch member includes a first socket and a second socket. A first speaker is installed in the first socket. The first speaker in the first socket is directed to a first area associated with the boat, and the first speaker is configured to provide directional audio to the first area. A second speaker is installed in the second socket. The second speaker in the second socket is directed to a second area associated with the boat, and the second speaker is configured to provide directional audio to the second area.

In some examples, a boat includes a boat frame including a boat deck and an arch coupled to the boat frame. A plurality of speakers are integrated within the arch to provide directional audio to a plurality of different areas associated with the boat.

The present disclosure describes techniques for integrating a speaker system in an arch of a boat. The speaker system includes a sound bar, according to some examples. An integrated arch speaker provides an audio system for the boat. In some examples, the arch is positioned overhead relative to a boat deck, and the elevated position of the arch provides a direct sound path from one or more speakers to one or more target areas of the boat. The direct sound path permits line-of-sound projection from the arch to multiple zones of the boat with reduced obstruction from seating, furniture, passengers, or other structures on the boat deck, relative to speakers mounted in seats, consoles, or other deck-level structures.

In some examples, the one or more speakers are configured to provide directional audio using beamforming, or otherwise using one or more speaker drivers within a speaker to steer, focus, or otherwise shape an audio output, for instance toward a target area. In some examples, the beamforming is achieved by controlling a phase, a timing, an amplitude, or a combination thereof of audio signals output by the one or more speaker drivers. In some examples, the beamforming concentrates audio output within a defined zone while reducing audio output outside the defined zone. In other examples, the one or more speakers provide directional audio based on a physical orientation or angle of the speaker within the arch rather than beamforming. In some examples, the one or more speakers provide directional audio using a combination of physical orientation and beamforming. In some examples, the integrated speaker delivers directional sound to an area in or outside of the boat, for instance to provide a controlled audio environment.

In some examples, the arch includes a forward-swept arch profile, a back-swept arch profile, or a combination thereof. For instance, in a forward-swept arch profile, the arch extends from a boat frame in a direction toward a bow of the boat, and the one or more speakers are positioned to provide a direct sound path to one or more areas at or near the bow, aft, or an area between the bow and aft, according to some examples. In a back-swept arch profile, the arch extends from the boat frame in a direction toward an aft of the boat, and the one or more speakers are positioned to provide a direct sound path to one or more areas at or near the aft, bow, or the area between the bow and aft, according to some examples. For instance, in some of such examples, the back-swept arch profile positions the one or more speakers to direct audio to an area behind the boat, for instance to a person in the water.

This overview is intended to provide an overview of the subject matter of the present patent application. It is not intended to provide an exclusive or exhaustive explanation of the invention. The detailed description is included to provide further information about the present patent application.

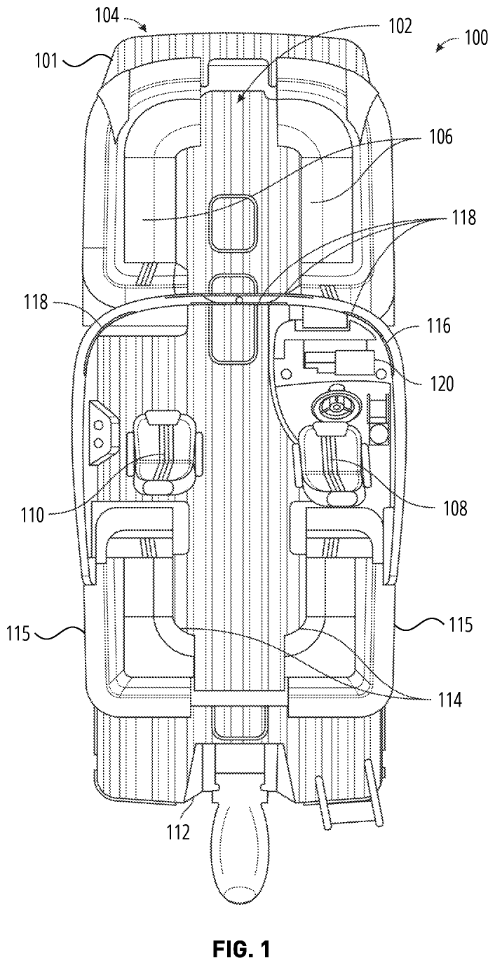

FIG. 1 is a top view of an example of a boat 100, including the integration of one or more speakers 118 into an arch 116. In FIG. 1, the boat 100 is shown as a pontoon boat. In some examples, the integrated speaker technology described herein is applicable to various types of boats, such as ski boats, wakeboard boats, deck boats, or the like. A deck 102 serves as the main platform of the boat. The deck 102 provides a foundation for the arrangement of seating or other components. At the front of the boat is a bow 104, which is the forward part of the boat 100. In examples, one or more sofa seats 106 are provided in the area by the bow 104 to provide a seating arrangement for a passenger.

In examples, the boat 100 includes a boat frame 101. The boat frame 101 provides structural support for the boat 100. In some examples, the boat frame 101 includes the deck 102 and one or more structural members (e.g., cross members, longitudinal members, C-channel members, or the like) coupled to the deck 102.

In examples, the boat 100 includes a driver seat 108, for instance to facilitate navigation or control of the boat 100. In some examples, the driver seat 108 is located at or near the navigation controls of the boat 100. The boat 100, in some examples, includes a co-captain seat 110, for instance adjacent to the driver seat 108.

The boat 100 includes an aft 112, which, in some examples, is located at or near the rear of the boat. In examples, the aft 112 is used for seating or storage. For example, the boat 100 includes a sofa seat 114 in some examples. The sofa seat 114 provides a seating arrangement for one or more passengers, for instance.

In some examples, the boat 100 includes a sidewall 115. The sidewall 115 extends along at least a portion of a periphery of the deck 102, according to some examples. In some examples, the sidewall 115 includes a railing, a wall panel, a fence, or the like. In some examples, the sidewall 115 extends along one or more of a port side, a starboard side, an aft side, a bow side, or a combination thereof of the boat 100.

In examples, the boat 100 includes the arch 116. The arch 116 is a structural framework that is coupled to at least a portion of the boat frame 101. For instance, the arch 116 includes a support structure coupled to the boat frame 101. The arch 116 includes, in some examples, an overhead or otherwise elevated structure (e.g., relative to the boat frame 101, the deck 102, or the like). For instance, the arch 116 extends above the deck 102 between one or more mounting locations on the boat frame 101. As used herein, the term “arch” refers to a support structure that includes, but is not limited to, a profile that is curved, arcuate, angular, straight, or other shape. For instance, in various examples, the arch 116 includes a T-top, a hardtop, a radar arch, a wakeboard tower, a top frame, a roll bar, or other structure that extends at least partially above the deck 102.

In the example illustrated in FIG. 1, the arch 116 is coupled to the deck 102 of the boat 100 at the first end portion 122, the second end portion 124, or a combination thereof, according to some examples. The arch 116 serves various purposes according to some examples. For instance, the arch 116 supports a canopy top, a hardtop, or other overhead covering, according to various examples. In some of such examples, the overhead covering is positioned above, behind, or to the side of the one or more speakers 118 so that the overhead covering does not obstruct the direct sound path between the one or more speakers 118 and a target area. For instance, in some examples, the one or more speakers 118 are mounted on a portion of the arch 116 that is below or forward of the overhead covering so that the one or more speakers 118 face or are directed to the target area without obstruction from the overhead covering.

In some examples, the overhead covering reflects, absorbs, attenuates, or otherwise modifies an audio output from the one or more speakers 118. In some of such examples, the audio control system 120 compensates for the presence of the overhead covering by adjusting a volume, an equalization, a speaker orientation, a beamforming parameter, or a combination thereof, of the one or more speakers 118. For instance, in some examples, the audio control system 120 stores one or more audio profiles corresponding to a covering-deployed state, a covering-stowed state, or a combination thereof. In some of such examples, the audio control system 120 applies a respective audio profile based on the state of the overhead covering.

In some examples, the arch 116 is made of, comprises, or otherwise includes carbon fiber, plastic, metal, fiberglass, composite material, or the like. In some examples, a material of the arch 116 affects acoustic transmission, reflection, or resonance of audio output from the one or more speakers 118. In some examples, the arch 116 includes an acoustically dampening material, an acoustic liner, an acoustic insulation, or a combination thereof, for instance at least partially within an interior of the arch 116 to reduce resonance or vibration of the arch 116 (e.g., caused by audio output from the one or more speakers 118). In some examples, the arch 116 includes a rigid material (e.g., carbon fiber, fiberglass, metal, or the like) that reduces vibration-induced distortion relative to a flexible (e.g., plastic or the like) material. In some examples, the enclosure 130 of a speaker of the one or more speakers 118 is at least partially acoustically isolated from the arch 116 by a gasket, a vibration dampener, a mounting isolator, or a combination thereof, for instance, to reduce transmission of vibration between the speaker and the arch 116.

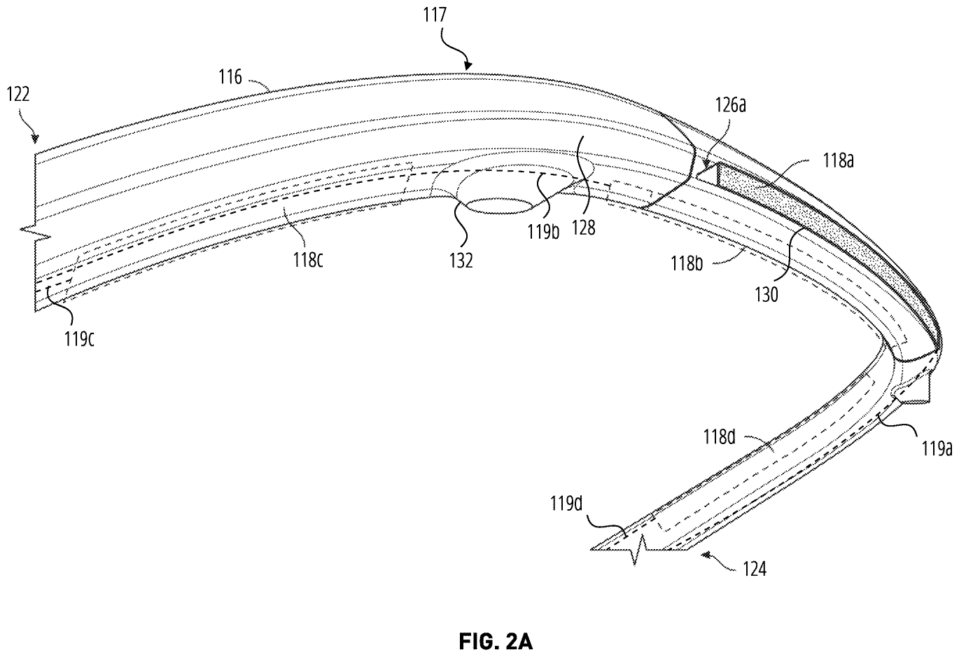

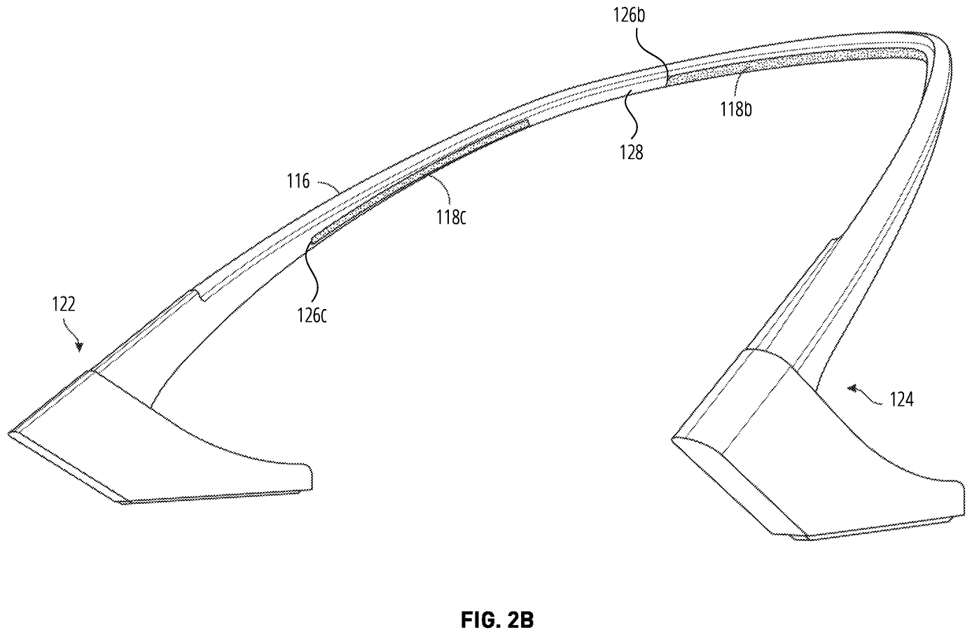

In some examples, the arch 116 is provided as a unitary structure. For instance, in some of such examples, the one or more speakers 118 are integrated into the unitary structure during manufacturing of the arch 116. In other examples, the one or more speakers 118 are installable into the unitary structure after manufacturing. In other examples, the arch 116 includes a multi-part structure. For instance, in some of such examples, the multi-part structure includes a modular arch having one or more arch segments. In some examples, an arch segment includes a socket and a speaker and is provided as a modular speaker segment that is attachable to and detachable from one or more other arch segments. For instance, the modular speaker segment is provided as an aftermarket component configured for installation on an existing boat or an existing arch. In some examples, the arch 116 includes a top or another similar structure that, for instance, extends over a helm of the boat 100. In some examples, the boat 100 includes one or more speakers 118. Optionally, the one or more speakers 118 are integrated into the arch 116. In other examples, the one or more speakers 118 are mounted to the arch 116, coupled to the arch 116, or the like. In some examples, the arch 116 includes one or more sockets (e.g., a first socket 126a, a second socket 126b, a third socket 126c, or the like, as described with reference to FIGS. 2A-2B). The one or more speakers 118 (e.g., a sound bar, a sound base, a wireless speaker, a portable speaker, a smart speaker, or the like) are inserted or otherwise attached to a respective socket, according to some examples. The arch 116 includes any number of sockets (e.g., 1, 2, 3, 4, 5, 6, or more), and a respective speaker is installed in each socket, according to various examples.

In some examples, the sockets 126 include one or more sockets of different sizes. In some of such examples, a size of a socket corresponds to a type of speaker installed in the socket. For instance, a larger socket accommodates a speaker configured to reproduce lower frequency audio, such as a subwoofer or a mid-range driver, and a smaller socket accommodates a speaker configured to reproduce higher frequency audio, such as a tweeter or a full-range driver, according to some examples. In some of such examples, a frequency response characteristic of a speaker of the one or more speakers 118 corresponds to a size of the respective socket in which the speaker is installed. In some examples, the arch 116 includes a combination of socket sizes to accommodate a combination of speaker types that together reproduce a range of audio frequencies.

In some examples, the one or more speakers 118 are integrated into the arch 116 at a specific location or angle to deliver directional sound to a specific area inside or outside of the boat. For instance, in some examples, directionality is achieved by a physical orientation of a speaker of the one or more speakers 118 within the arch 116. For instance, a cone speaker, a coaxial speaker, or a component speaker is angled within a respective socket to face a target area, and the physical orientation of the speaker directs audio output toward the target area, according to some examples.

In some examples, directionality is achieved by beamforming, in which one or more speaker drivers within a speaker of the one or more speakers 118 are driven with controlled phase, timing, or amplitude differences to steer audio output toward a target area. In other examples, directionality is achieved by a planar speaker, such as a planar magnetic speaker or an electrostatic speaker, that radiates audio in a direction perpendicular to a plane of the speaker. In some examples, directionality is achieved by any combination of physical orientation, beamforming, planar orientation, or the like.

The directional sound provides a controlled audio environment, for instance. By integrating the one or more speakers 118 into the arch 116, the arch 116 permits directional audio, for instance, from an elevated position relative to the deck 102. The elevated position provides a direct sound path to one or more target areas with reduced obstruction from seating, furniture, passengers, or other structures on the deck 102. In some examples, the one or more speakers 118 are arranged in a multi-channel configuration, such as a 2.1, 3.1, 5.1, 7.1.4, or other multi-channel configuration.

In various examples, the arch 116 includes a forward-swept profile, a back-swept profile, a vertical profile, or a combination thereof. For instance, in the forward-swept profile, the arch 116 extends from the boat frame 101 in a direction toward the bow 104 of the boat 100. In the back-swept profile, the arch 116 extends from the boat frame 101 in a direction towards the aft 112 of the boat 100. In various examples, the forward-swept profile or the back-swept profile positions the one or more speakers 118 to direct audio to an area near the bow 104 of the boat 100, the aft 112 of the boat 100, an area between the bow 104 and the aft 112, or an area outside of the boat 100, for instance towards a person in the water (e.g., behind the boat 100, in front of the boat 100, aside the boat 100, or the like).

In examples, the boat 100 includes an audio control system 120. The audio control system 120 manages the audio system, including the one or more speakers 118. In some examples, the audio control system 120 includes an amplifier, a digital signal processor, a receiver, the one or more speakers 118, or a combination thereof. For instance, the amplifier provides power to or adjusts a power level of the one or more speakers 118 (e.g., based on how many speakers are active). The digital signal processor performs equalization, surround sound processing, time alignment, acoustic compensation, or the like, for instance, based on which audio zones are active. The receiver receives audio from one or more audio sources, such as a Bluetooth device, an AM/FM tuner, a solid-state drive, an auxiliary input, or the like. In some examples, the audio control system 120 independently controls the volume, equalization, or audio source for each speaker of the one or more speakers 118. The audio control system 120 permits a user to adjust one or more sound settings. For instance, the audio control system 120 permits the user to direct audio to a specific area of the boat, according to some examples. Optionally, the audio control system 120 is modular. In some of such examples, one or more components of the audio control system 120, such as the amplifier, the digital signal processor, or the receiver, are replaceable or upgradeable as aftermarket components.

The audio control system 120 is located in an area at or near the deck 102, bow 104, the one or more sofa seats 106, the driver seat 108, the co-captain seat 110, the aft 112, the sofa seat 114, the arch 116, or other location on the boat 100 according to some examples, for instance, to provide easy access to a passenger or driver of the boat 100. In some examples, the audio control system 120 is located at an outboard deck or along a sidewall 115 of the boat 100. For instance, in some examples, the audio control system 120 is housed within a console of the boat 100, beneath the deck 102, or in another protected location on the boat 100, according to various examples. In some examples, audio control is provided using an app on a mobile phone. The app is wirelessly connected to the audio control system 120, according to some examples. The app permits a passenger to customize the auditory experience from the mobile phone, for instance.

FIGS. 2A-2B are perspective views of an example of portions of the arch 116 with a first speaker 118a, a second speaker 118b, a third speaker 118c, and a fourth speaker 118d (collectively referred to as the one or more speakers 118). As illustrated in FIGS. 2A-2B, the one or more speakers 118 are integrated within the arch 116, according to some examples. The arch 116 serves as a structural framework for the integration of one or more speakers 118, according to some examples. The arch 116 is designed to accommodate the one or more speakers 118 at least partially within the structure, for instance, so that a speaker of the one or more speakers 118 is flush with, recessed relative to, or conforms to the outer surface 128 of the arch 116, according to some examples.

The arch 116, in some examples, includes a first end portion 122, a second end portion 124, or a combination thereof. The first end portion 122, the second end portion 124, or a combination thereof are configured for coupling with at least a portion of the boat frame 101, such as the deck 102, according to some examples.

In examples, the arch 116 includes an arch member 117. The arch member 117 extends between (e.g., at least partially, entirely, or the like) the first end portion 122 and the second end portion 124. The arch member 117 includes an arch profile. In the illustrated example, the arch member 117 includes a first socket 126a, a second socket 126b, and a third socket 126c (collectively the sockets 126). While the illustrated example shows three sockets, in other examples the arch 116 includes any number of sockets, for instance 1, 2, 3, 4, or more sockets. The arch 116 houses the one or more speakers 118 so that a speaker of the one or more speakers 118 is flush with an outer surface 128 of the arch 116, for instance, to reduce obstruction or to maintain an aesthetic appeal in some of such examples. In other examples, a speaker of the one or more speakers 118 projects from, or is recessed relative to, the outer surface 128 of the arch 116.

In examples, the arch 116 includes a socket for one or more of the one or more speakers 118. For instance, as illustrated in FIG. 2A, the arch 116 includes the first socket 126a, the second socket 126b, and the third socket 126c, according to some examples. The first socket 126a, the second socket 126b, and the third socket 126c receive at least a portion of the first speaker 118a, the second speaker 118b, and the third speaker 118c, respectively. In some examples, the one or more speakers 118 include a marine-grade rating (e.g., an IP rating, a water-resistance rating, or the like). In some examples, the sockets 126 include a gasket, a seal, or other water-resistant feature to inhibit water ingress into the arch 116.

The one or more speakers 118 are couplable to the arch 116 via a respective socket of the sockets 126, for instance by an insert clip, a mounting bracket and screw, a sliding mechanism, adhesive, or the like, according to some examples. For instance, the first speaker 118a is pushed into or otherwise placed within the first socket 126a and clipped into place, according to some examples. Each socket (e.g., the first socket 126a, the second socket 126b, the third socket 126c, or the like) facilitates the installation or maintenance of the respective speaker (e.g., the first speaker 118a, the second speaker 118b, the third speaker 118c, or the like), according to some examples. In some examples, the arch 116 includes one or more of the sockets 126 for insertion of the one or more speakers 118.

In some examples, the arch 116 is a unitary structure. For instance, the arch member 117, the first end portion 122, and the second end portion 124 are formed as a single continuous piece, according to some examples. In some of such examples, the sockets 126 are formed (e.g., molded, machined, cut, or the like) into the unitary structure.

As illustrated in FIGS. 2A-2B, the one or more speakers 118 are provided as a sound bar in some examples. For instance, the sound bar includes a modular audio component that includes one or more speaker drivers, one or more processing components, one or more amplification components, or a combination thereof, within an enclosure (e.g., the enclosure 130). For instance, the sound bar includes an amplifier, a digital signal processor, a receiver, or a combination thereof within the enclosure 130. In some of such examples, the sound bar receives an audio source signal and independently drives or coordinates a speaker driver, for instance without external amplification or processing. Each sound bar includes one or more speakers, amplifiers, or a combination thereof within an enclosure (e.g., the enclosure 130), according to some examples. For instance, each sound bar includes any number of individual speaker drivers (e.g., 1, 2, 3, 4, 6, 8, or more) within the enclosure 130, according to various examples. In examples, the first speaker 118a comprises a first sound bar and the second speaker 118b comprises a second sound bar. In other examples, the one or more speakers 118 include a different speaker type, such as a coaxial speaker, a component speaker, a subwoofer, or the like. In some examples, a sound bar of the one or more speakers 118 is a passive sound bar that receives an amplified signal from an external amplifier of the audio control system 120.

In some examples, a speaker of the one or more speakers 118 includes a sound bar. For instance, the sound bar includes one or more speakers or amplifiers within an enclosure 130. The enclosure 130 houses the speaker components and amplifier components of the sound bar, according to some examples. In some examples, the enclosure 130 is shaped to conform to the profile of the arch 116 or the arch member 117. For instance, a size of the enclosure 130 is constrained by a cross-sectional dimension of the arch member 117, such as a thickness or a width of the arch member 117, according to some examples. For example, the enclosure 130 is elongate along a length of the arch member 117 and has a depth that corresponds with a cross-sectional dimension of the arch member 117, according to some examples. In some examples, the enclosure 130 is shaped to fit within or correspond to a respective socket of the sockets 126 so that the enclosure 130 is received at least partially within the arch member 117.

In some examples, the enclosure 130 includes a rectangular, elongate, circular, or otherwise shaped housing. In some examples, the arch member 117 includes one or more load-bearing structures, such as a canopy support, a wakeboard tower support, or the like. In some of such examples, the sockets 126, the enclosure 130, or a combination thereof are positioned along the arch member 117, for instance, apart from the one or more load-bearing structures. In some examples, a size, a shape, or a position of the enclosure 130 along the arch member 117 is selected based on a location of the one or more load-bearing structures within the arch member 117.

As illustrated in the example shown in FIG. 2A, the first speaker 118a projects from at least a portion of the arch 116, for instance, the outer surface 128 of the arch 116. As illustrated in the example shown in FIG. 2B, the second speaker 118b and the third speaker 118c are flush with at least a portion of the arch 116, for instance, the outer surface 128 of the arch 116. Flush refers to being at the same level as the outer surface 128 of the arch 116 within a given tolerance. For example, flush refers to being at the same level as the outer surface 128 within 0-2, 0-1, 0.5-0.7, or 0.1-0.5 inches, according to some examples. For instance, a profile of the second speaker 118b and the third speaker 118c corresponds to, or is otherwise similar to, a profile of the second socket 126b and the third socket 126c, respectively, according to some examples.

While the examples illustrated in FIGS. 2A and 2B show the first speaker 118a projecting from at least a portion of the arch 116 and the second speaker 118b and the third speaker 118c flush with the outer surface 128, in other examples, any combination of the one or more speakers 118 are flush, recessed, or protrude relative to the outer surface 128. For instance, in some examples, the first speaker 118a is flush with the arch 116 or the profile of the arch 116 or arch member 117.

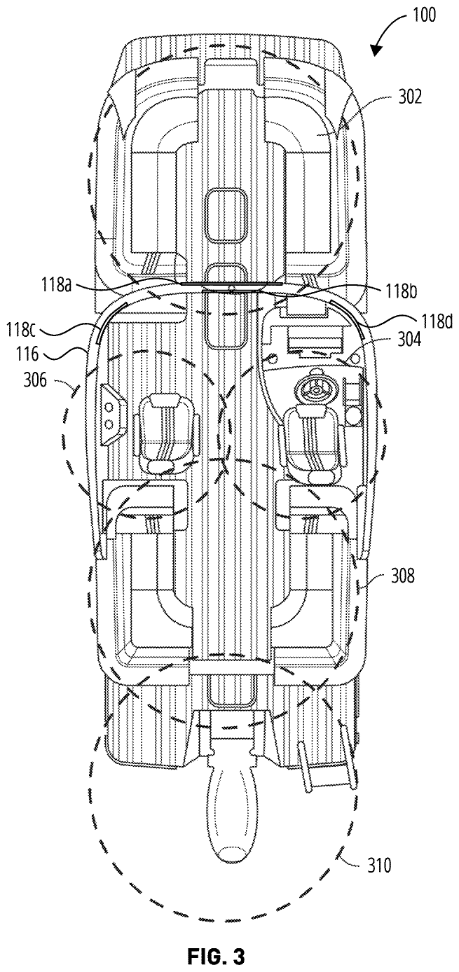

In some examples, the one or more speakers 118 are placed or otherwise located (e.g., positioned, oriented, angled, or the like) to provide directional audio to a specific zone associated with the boat, as described herein and with reference to FIG. 3.

In some examples, the one or more speakers 118 are integrated into the arch 116 at a specific location or angle, for instance to deliver directional sound to a specific area inside or outside of the boat. Directionality is achieved, for instance, by physical orientation of a speaker within a respective socket, by beamforming using one or more speaker drivers, by a planar speaker, or by a combination thereof. In some examples, beamforming steers audio output by controlling phase, timing, or amplitude differences among the one or more speaker drivers, for instance, to produce constructive interference in a target direction and destructive interference in another direction. The directional sound provides a controlled audio environment, for instance. By integrating the one or more speakers 118 into the arch 116, the arch 116 permits directional audio, for instance from an overhead position relative to the deck 102 (e.g., with a direct sound path to one or more target areas).

In some examples, the boat 100 includes one or more wiring harnesses. For instance, in the example illustrated in FIG. 2A, the boat 100 includes a first wiring harness 119a, a second wiring harness 119b, a third wiring harness 119c, and a fourth wiring harness 119d (collectively the one or more wiring harnesses 119). In examples, the first wiring harness 119a, the second wiring harness 119b, the third wiring harness 119c, and the fourth wiring harness 119d connect the first speaker 118a, the second speaker 118b, the third speaker 118c, and the fourth speaker 118d, respectively, to the audio control system 120 of FIG. 1. In some examples, each speaker of the one or more speakers 118 is connected to the respective wiring harness via a plug connector, a terminal block, a soldered connection, or the like.

In various examples, a wiring harness (e.g., the first wiring harness 119a, the second wiring harness 119b, the third wiring harness 119c, the fourth wiring harness 119d, or the like) of the one or more wiring harnesses 119 is provided inside the arch 116, as shown in FIG. 2A. The one or more wiring harnesses 119 run through at least a portion of an interior of the arch 116, according to some examples. In some examples, the one or more wiring harnesses 119 communicate a control signal, a power signal, or a combination thereof between a respective speaker of the one or more speakers 118 and the audio control system 120 of FIG. 1. In some examples, the boat 100 includes any number of wiring harnesses (e.g., 1, 2, 3, 4, 5, 6, or more), for instance, with each wiring harness connecting one or more respective speakers to the audio control system 120.

In some examples, one or more of the one or more speakers 118 include a wireless transceiver. The wireless transceiver communicates audio control information, according to some examples.

In some examples, the boat 100 includes a light 132. For instance, as illustrated in FIG. 2A, the arch 116 includes the light 132. The light 132 is coupled to or otherwise integrated with the one or more speakers 118, according to some examples. For instance, a light-emitting diode (LED) is provided near or adjacent to the one or more speakers 118 in some examples. In some examples, the LED is controlled based on an audio output of a speaker of the one or more speakers 118. For example, the LED flashes synchronized with music being played from the one or more speakers 118, according to some examples.

FIG. 3 is a top view of another example of the boat 100, including a plurality of audio zones (e.g., a bow zone 302, a driver-centric zone 304, a co-captain zone 306, an aft zone 308, and an outside zone 310). The plurality of audio zones are facilitated by a speaker system (e.g., the one or more speakers 118) within the arch 116, as described herein. Each zone of the plurality of audio zones corresponds to one or more areas of the boat 100. The one or more speakers 118 within the arch are positioned and angled to direct audio towards one or more of the audio zones, according to some examples. As shown in the example illustrated in FIG. 3, the boat 100 includes the bow zone 302, the driver-centric zone 304, the co-captain zone 306, the aft zone 308, and the outside zone 310. In other examples, the boat 100 includes any number or combination of audio zones.

The bow zone 302 is located at the front of the boat. The bow zone 302 corresponds to the area at or near the bow 104 of FIG. 1. A passenger gathers in the bow zone 302 for a view or relaxation, for instance. In the example illustrated in FIGS. 2A-2B, the first speaker 118a is positioned or angled (e.g., in the arch 116) to face the bow of the boat 100 (e.g., the bow 104 of FIG. 1), for instance, to provide directional audio to the bow zone 302.

The driver-centric zone 304 is situated near the driver's seat, according to some examples. For instance, the driver-centric zone 304 corresponds to the area at or near the driver seat 108 of FIG. 1. In the example illustrated in FIGS. 2A-2B, the third speaker 118c is positioned and angled in the arch 116 to provide directional audio to the driver-centric zone 304. The directional audio permits communication and entertainment for the driver while the driver is operating the boat, for instance.

The co-captain zone 306 is adjacent to the driver-centric zone 304, according to some examples. The co-captain zone 306 corresponds to the area at or near the co-captain seat 110 of FIG. 1. The co-captain zone 306 is designated for the co-captain or an additional passenger, according to some examples. In the example illustrated in FIGS. 2A-2B, the fourth speaker 118d is positioned and angled in the arch 116 to provide directional audio to the co-captain zone 306.

The aft zone 308 is located at the rear of the boat. The aft zone 308 corresponds to the area at or near the aft 112 of FIG. 1. The aft zone 308 is used for passenger seating, for instance. In the example illustrated in FIGS. 2A-2B, the second speaker 118b is positioned or angled (e.g., in the arch 116) to provide directional audio to the aft zone 308.

The outside zone 310 extends beyond a border of the boat 100, such as beyond the aft zone 308, the bow zone 302, the driver-centric zone 304, the co-captain zone 306, the sidewall 115 of the boat 100, an exterior boundary of the boat 100, or the like. The outside zone 310 includes space outside a boundary of the boat 100, according to some examples. The outside zone 310 caters to an activity that occurs outside the boat, such as wakeboarding, water-skiing, tubing, or the like. A speaker of the one or more speakers 118 is positioned to direct audio towards the outside zone 310, according to some examples. In some examples, a speaker directed to the outside zone 310 has a different frequency response, power level, or directionality configuration than a speaker directed to an interior zone of the boat 100. For instance, a speaker directed to the outside zone 310 is configured with a higher output level or a narrower directional pattern to project audio over a greater distance relative to a speaker directed to an interior zone, according to some examples. For instance, the speaker of the one or more speakers 118 provides directional audio to areas outside of the boat 100 (e.g., behind the aft zone 308, in front of the bow zone 302, beyond the sidewall 115, beyond a boundary of the boat 100, or the like), according to some examples.

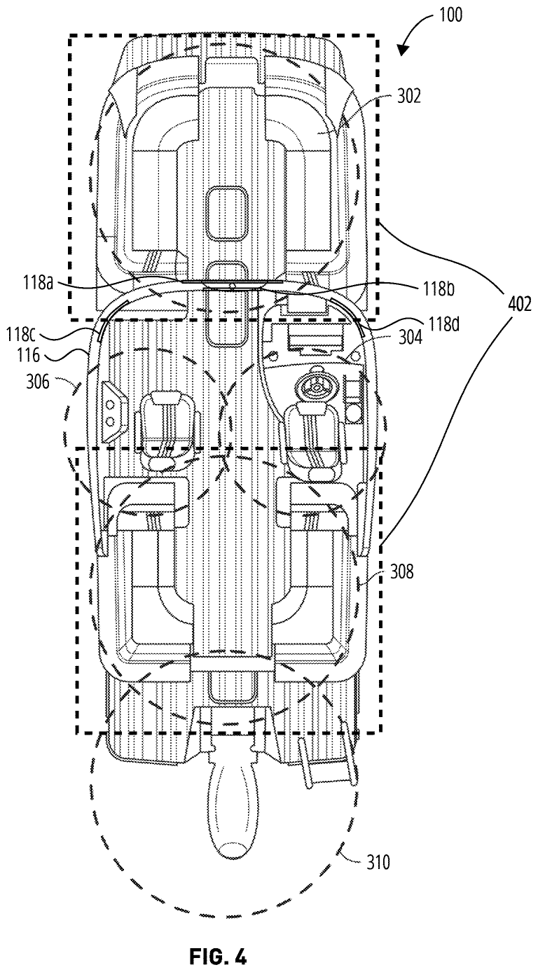

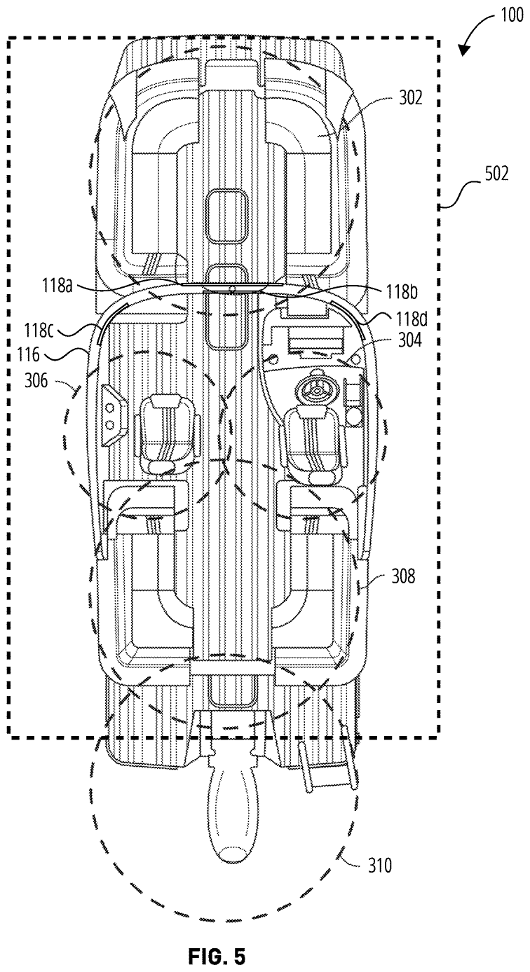

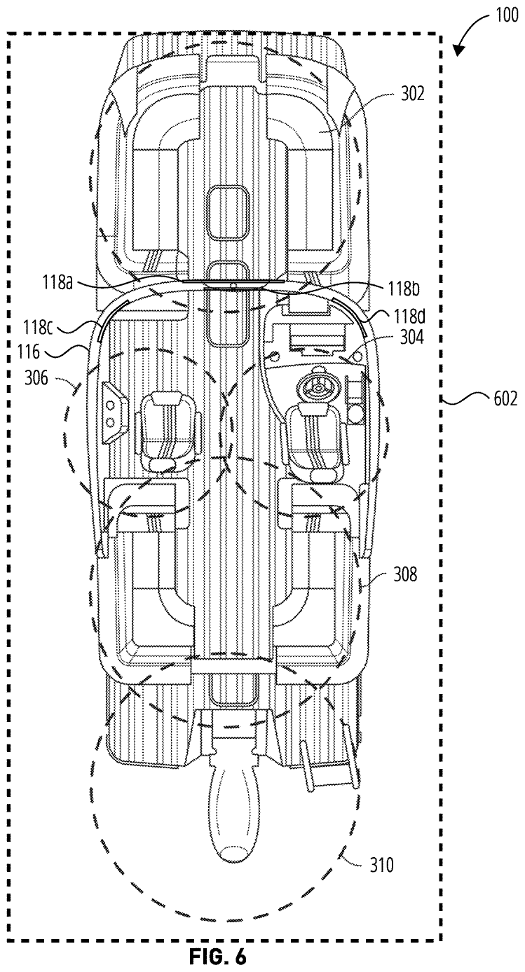

The configuration of the one or more speakers 118 is used to pre-program one or more different audio settings, according to some examples. For instance, FIGS. 4-6 show example pre-configured audio settings facilitated by the integrated speaker system within the arch 116. The pre-configured audio settings include a passenger zone 402 (of FIG. 4), a surround sound zone 502 (of FIG. 5), a party zone 602 (of FIG. 6), or the like, according to various examples. By selecting a pre-configured audio setting, the user selects a group of one or more of the audio zones (e.g., the bow zone 302, the driver-centric zone 304, the co-captain zone 306, the aft zone 308, the outside zone 310, or the like) to receive audio from the one or more speakers 118.

FIG. 4 is a top view of another example of the boat 100, including an example of a pre-configured audio setting of the passenger zone 402, facilitated by an integrated speaker system (e.g., the one or more speakers 118) within the arch 116.

The passenger zone 402 is set by activating the bow zone 302 and aft zone 308 (e.g., concurrently) by using a corresponding speaker of the one or more speakers 118 in the arch 116, according to some examples. In the passenger zone 402, a passenger in the bow zone 302 or the aft zone 308 enjoys an immersive audio experience, according to some examples. In the illustrated example, the driver-centric zone 304 and co-captain zone 306 are not activated, which permits a passenger in those zones to converse more easily, for instance. In other examples, the passenger zone includes any combination of the bow zone 302, the driver-centric zone 304, the co-captain zone 306, the aft zone 308, the outside zone 310, or the like.

FIG. 5 is a top view of another example of the boat 100, including an example pre-configured audio setting of the surround sound zone 502 facilitated by an integrated speaker system (e.g., the one or more speakers 118) within the arch 116. In the surround sound zone 502, all audio zones within the boat (e.g., the bow zone 302, the driver-centric zone 304, the co-captain zone 306, and the aft zone 308) are activated using the corresponding integrated speakers in the arch 116, according to some examples. In other examples, the surround sound zone includes any combination of the bow zone 302, the driver-centric zone 304, the co-captain zone 306, the aft zone 308, the outside zone 310, or the like.

FIG. 6 is a top view of another example of the boat 100, including an example pre-configured audio setting of the party zone 602 facilitated by an integrated speaker system (e.g., the one or more speakers 118) within the arch 116. In the party zone 602, all areas within (e.g., the bow zone 302, the driver-centric zone 304, the co-captain zone 306, and the aft zone 308) and outside (e.g., the outside zone 310) the boat 100 are activated using the corresponding speakers of the one or more speakers 118.

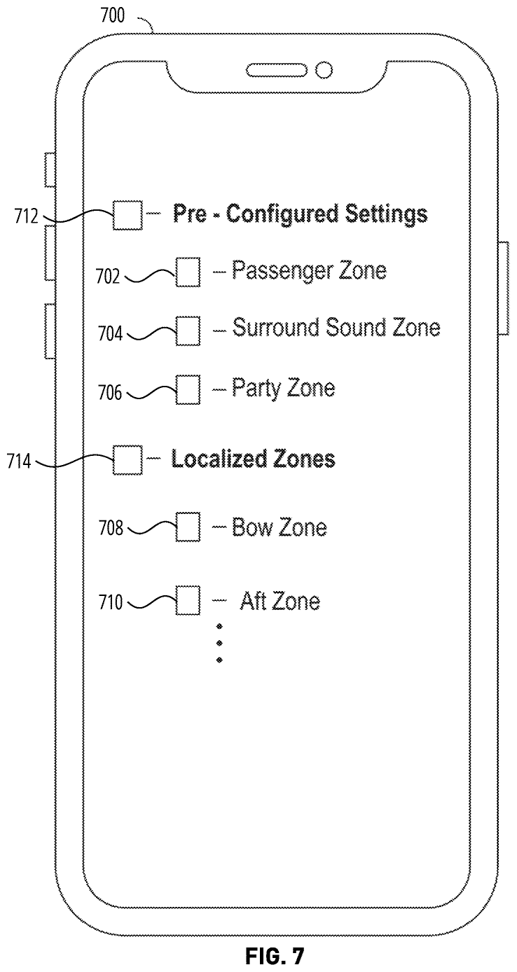

FIG. 7 is an example user interface 700 including example portions for configuring the audio settings of FIGS. 4-6. In some examples, the user interface 700 is provided by an app on a mobile phone, for instance, as illustrated in FIG. 7. In some examples, the user interface 700 is provided on a console screen on the boat, for instance at or near the driver seat 108. In some examples, the user interface 700 is provided on a tablet, a touchscreen display, a smartwatch, or other user device. In some examples, the user interface 700 is provided during a recreational mode, for instance, a float mode, a trolling mode, an anchor mode, or the like.

In the example illustrated in FIG. 7, the user interface 700 includes a text-based layout with one or more selectable indications. In other examples, the user interface 700 includes a graphical layout that displays a representation of the boat 100, one or more of the audio zones, or a combination thereof. In some of such examples, a user selects an audio zone by interacting with a corresponding region of the representation of the boat 100 displayed in the graphical layout. Optionally, the user interface 700 includes both the text-based layout and the graphical layout. The user switches between the text-based layout and the graphical layout, for instance, depending on a viewing preference.

In some examples, the app communicates with a remote server or a cloud-based service. For instance, the remote server or cloud-based service stores user account information, audio profiles, usage data, diagnostic data, or a combination thereof associated with the boat 100 or the audio control system 120. In some examples, the remote server or cloud-based service provides software updates to the app, the audio control system 120, or a combination thereof.

In some examples, the audio settings facilitated by the speaker system are set via the user interface 700. For instance, the user interface 700 is provided on a control panel in the boat, for instance, near the driver seat 108 of FIG. 1. In other examples, an app is installed on a mobile phone, and the app provides the user interface 700. Interaction with the user interface 700 configures the audio settings. Optionally, the mobile phone wirelessly communicates with the audio control system 120 to adjust audio settings. The wireless connection includes, but is not limited to, Bluetooth, Wi-Fi, near-field communication (NFC), or other wireless communication protocols.

The user interface 700 permits the user to set one or more pre-configured settings, according to some examples. For instance, the user interface 700 includes one or more selectable indications corresponding to one or more of the pre-configured settings (e.g., the passenger zone 402 of FIG. 4, the surround sound zone 502 of FIG. 5, the party zone 602 of FIG. 6, or the like), one or more of the localized zones (e.g., the bow zone 302, the driver-centric zone 304, the co-captain zone 306, the aft zone 308, the outside zone 310, or the like), or the like. In some examples, each selectable indication includes a checkbox, a toggle, a button, a slider, a radio button, or other selectable or operable elements within the user interface 700.

In the example illustrated in FIG. 7, the user interface 700 includes a first grouped selectable indication 712 and a second grouped selectable indication 714. In this example, the first grouped selectable indication 712 corresponds to a pre-configured settings group. The second grouped selectable indication 714 corresponds to a localized zones group. Optionally, the first grouped selectable indication 712 and the second grouped selectable indication 714 each include a respective selectable element (e.g., a checkbox, a toggle, or the like). In some examples, selection of the first grouped selectable indication 712 automatically selects all selectable indications within the pre-configured settings group. For instance, when a user selects the first grouped selectable indication 712, the first selectable indication 702, the second selectable indication 704, and the third selectable indication 706 are each automatically selected. In some examples, deselection of the first grouped selectable indication 712 automatically deselects all selectable indications within the pre-configured settings group, and selection of the second grouped selectable indication 714 automatically selects all selectable indications within the localized zones group. For instance, when a user selects the second grouped selectable indication 714, the fourth selectable indication 708, the fifth selectable indication 710, and any additional localized zone selectable indications are each automatically selected. In some examples, deselection of the second grouped selectable indication 714 automatically deselects all selectable indications within the localized zones group.

The user interface 700 includes the first selectable indication 702, the second selectable indication 704, and the third selectable indication 706, according to some examples. For instance, the first selectable indication 702, the second selectable indication 704, and the third selectable indication 706 are included within the pre-configured settings group associated with the first grouped selectable indication 712, according to some examples. In the illustrated example, the first selectable indication 702 corresponds to the passenger zone 402 (of FIG. 4). In the illustrated example, the second selectable indication 704 corresponds to the surround sound zone 502 (of FIG. 5). In the illustrated example, the third selectable indication 706 corresponds to the party zone 602 (of FIG. 6). In some examples, when the user selects one of the first selectable indication 702, the second selectable indication 704, the third selectable indication 706, or a combination thereof, the audio control system 120 of FIG. 1 activates the corresponding combination of audio zones (e.g., as described with respect to FIGS. 4-6) using the one or more speakers 118 in the arch 116. In some examples, the user selects one of the first selectable indication 702, the second selectable indication 704, or the third selectable indication 706 individually, for instance without selecting the first grouped selectable indication 712.

The user interface 700 includes a fourth selectable indication 708 and a fifth selectable indication 710, according to some examples. For instance, the fourth selectable indication 708 and the fifth selectable indication 710 are included within the localized zones group associated with the second grouped selectable indication 714, according to some examples. In the illustrated example, the fourth selectable indication 708 corresponds to the bow zone 302 (of FIG. 3), and the fifth selectable indication 710 corresponds to the aft zone 308 (of FIG. 3). In some examples, additional localized zones are selectable. For instance, the localized zones group includes additional selectable indications corresponding to the driver-centric zone 304, the co-captain zone 306, the outside zone 310, or other zones associated with the boat 100, according to some examples.

The user independently activates or deactivates each localized zone by selecting the respective selectable indication. Optionally, the user creates a custom combination of active zones by selecting two or more of the localized zone selectable indications individually, for instance without selecting the second grouped selectable indication 714.

In some examples, the user interface 700 includes a volume control for each zone, each pre-configured setting, or a combination thereof. For instance, the user adjusts the volume of the bow zone 302 independently from the aft zone 308, according to some examples. Optionally, the user interface 700 includes an equalizer control, a bass control, a treble control, or other audio adjustment for one or more of the zones.

In some examples, a user-customizable audio profile is created using the user interface 700. Optionally, the user-customizable audio profile is stored and recalled for later use. For instance, the user creates a custom audio profile that activates a particular combination of zones at particular volume levels, and stores the custom audio profile for selection at a later time, according to some examples. In some examples, the user interface 700 permits the user to name, edit, delete, or reorder the stored audio profiles. In some examples, the user interface 700 stores one or more audio profiles, such as 1, 2, 3, 5, 10, or more stored audio profiles.

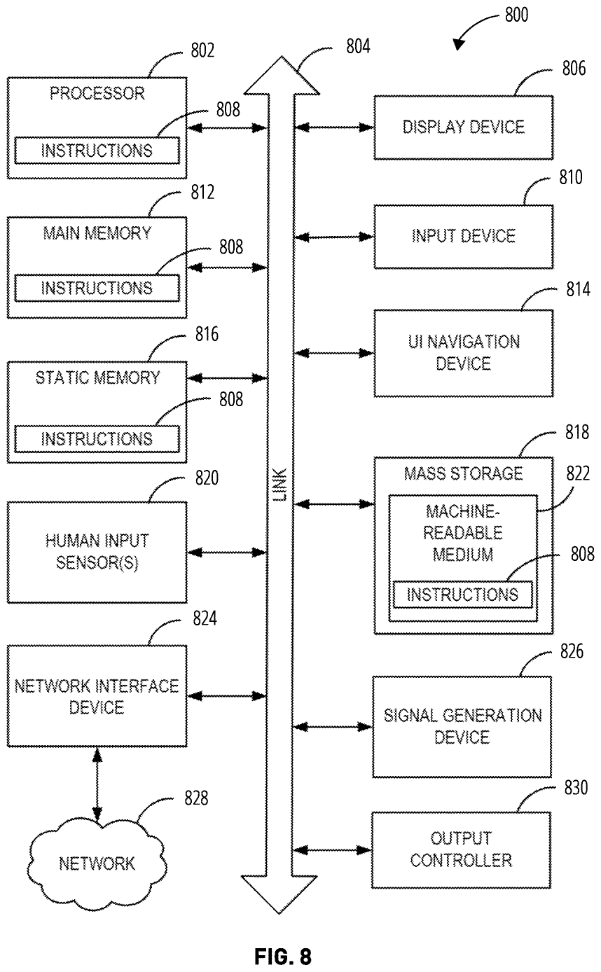

FIG. 8 illustrates a block diagram of an example machine 800 upon which any one or more of the techniques (e.g., methodologies) discussed herein may perform. Examples, as described herein, may include, or may operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 800 follow.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 800 (e.g., computer system) may include a hardware processor 802 (e.g., a central processing unit (CPU), a graphics processing unit (GPU), a hardware processor core, or any combination thereof), a main memory 812, a static memory 816, such as memory or storage for firmware, microcode, a basic-input-output (BIOS), unified extensible firmware interface (UEFI), etc., and mass storage 818 (e.g., hard drive, tape drive, flash storage, or other block devices), some or all of which may communicate with each other via an interlink (e.g., bus) 804. The machine 800 may further include a display unit 806, an alphanumeric input device 810 (e.g., a keyboard), and a user interface navigation device 814 (e.g., a mouse). In an example, the display unit 806, the alphanumeric input device 810, and the user interface navigation device 814 may be a touch screen display. The machine 800 may additionally include a storage device (e.g., drive unit), a signal generation device 826 (e.g., a speaker), a network interface device 824, and one or more sensors 820, such as a global positioning system (GPS) sensor, compass, accelerometer, or other sensor. The machine 800 may include an output controller 830, such as a serial (e.g., universal serial bus (USB)), parallel, or other wired or wireless (e.g., infrared (IR), near field communication (NFC), etc.) connection to communicate or control one or more peripheral devices (e.g., a printer, card reader, etc.).

Registers of the hardware processor 802, the main memory 812, the static memory 816, or the mass storage 818 may be, or include, a machine-readable medium 822 on which is stored one or more sets of data structures or instructions 808 (e.g., software) embodying or utilized by any one or more of the techniques or functions described herein. The instructions 808 may also reside, completely or at least partially, within any of the registers of the hardware processor 802, the main memory 812, the static memory 816, or the mass storage 818 during execution thereof by the machine 800. In an example, one or any combination of the hardware processor 802, the main memory 812, the static memory 816, or the mass storage 818 may constitute the machine-readable medium 822. While the machine-readable medium 822 is illustrated as a single medium, the term “machine-readable medium” may include a single medium or multiple media (e.g., a centralized or distributed database, and/or associated caches and servers) configured to store the instructions 808.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine-readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 808 may be further transmitted or received over a communications network 828 using a transmission medium via the network interface device 824 utilizing any one of a number of transfer protocols (e.g., frame relay, Internet Protocol (IP), Transmission Control Protocol (TCP), User Datagram Protocol (UDP), Hypertext Transfer Protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, peer-to-peer (P2P) networks, among others. In an example, the network interface device 824 may include one or more physical jacks (e.g., Ethernet, coaxial, or phone jacks) or one or more antennas to connect to the communications network 828. In an example, the network interface device 824 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800, and includes digital or analog communications signals or other intangible medium to facilitate communication of such software. A transmission medium is a machine-readable medium.

### Additional Notes and Aspects

Example 1 is a boat comprising: a boat frame including a boat deck; an arch coupled to the boat frame, wherein the arch includes: a first socket, and a second socket; a first speaker installed in the first socket, wherein the first speaker in the first socket is directed to a first area associated with the boat and the first speaker is configured to provide directional audio to the first area; and a second speaker installed in the second socket, wherein the second speaker in the second socket is directed to a second area associated with the boat and the second speaker is configured to provide directional audio to the second area.

In Example 2, the subject matter of Example 1 optionally includes wherein the arch is a unitary structure.

In Example 3, the subject matter of Example 2 optionally includes wherein the unitary structure is comprised of carbon fiber.

In Example 4, the subject matter of any one or more of Examples 1-3 optionally includes an audio control system to control the first speaker and the second speaker.

In Example 5, the subject matter of Example 4 optionally includes a first wiring harness connecting the first speaker to the audio control system; and a second wiring harness connecting the second speaker to the audio control system; wherein the first wiring harness and the second wiring harness are provided inside the arch.

In Example 6, the subject matter of any one or more of Examples 1-5 optionally includes wherein the boat is a pontoon boat.

In Example 7, the subject matter of any one or more of Examples 1-6 optionally includes wherein the first speaker comprises a first sound bar and the second speaker comprises a second sound bar.

In Example 8, the subject matter of any one or more of Examples 1-7 optionally includes wherein the first speaker is flush with the arch.

Example 9 is an arch for a boat, comprising: a first end portion configured for coupling with a boat frame; a second end portion configured for coupling with the boat frame; an arch member extending between the first end portion and the second end portion having an arch profile, wherein the arch member includes a first socket and a second socket; a first speaker installed in the first socket, wherein the first speaker in the first socket is directed to a first area associated with the boat and the first speaker is configured to provide directional audio to the first area; and a second speaker installed in the second socket, wherein the second speaker in the second socket is directed to a second area associated with the boat and the second speaker is configured to provide directional audio to the second area.

In Example 10, the subject matter of Example 9 optionally includes wherein the arch is a unitary structure.

In Example 11, the subject matter of Example 10 optionally includes wherein the unitary structure is comprised of carbon fiber.

In Example 12, the subject matter of any one or more of Examples 9-11 optionally includes wherein the first speaker comprises a first sound bar and the second speaker comprises a second sound bar.

In Example 13, the subject matter of any one or more of Examples 9-12 optionally includes wherein: the first speaker is positioned to face a bow of the boat to provide directional audio to a bow area; and the second speaker is positioned to face an aft of the boat to provide directional audio to an aft area.

In Example 14, the subject matter of any one or more of Examples 9-13 optionally includes a first wiring harness for connecting the first speaker to an audio control system; and a second wiring harness for connecting the second speaker to the audio control system; wherein the first wiring harness and the second wiring harness are provided inside the arch.

In Example 15, the subject matter of any one or more of Examples 9-14 optionally includes wherein the first speaker is flush with the arch profile.

Example 16 is a boat comprising: a boat frame including a boat deck; an arch coupled to the boat frame; and a plurality of speakers integrated within the arch to provide directional audio to a plurality of different areas associated with the boat.

In Example 17, the subject matter of Example 16 optionally includes wherein the arch is a unitary structure.

In Example 18, the subject matter of Example 17 optionally includes wherein the arch comprises one or more sockets for insertion of the plurality of speakers.

In Example 19, the subject matter of any one or more of Examples 16-18 optionally includes an audio control system to control the plurality of speakers.

In Example 20, the subject matter of Example 19 optionally includes one or more wiring harnesses connecting the plurality of speakers to the audio control system, wherein the one or more wiring harnesses are provided inside the arch.

Example 21 is an apparatus comprising means to implement any of Examples 1-20.

Example 22 is a system to implement any of Examples 1-21.

Example 23 is a method to implement any of Examples 1-22.

Example 24 is a computer-readable medium to implement any of Examples 1-23.

In Example 25, the apparatuses or methods of any one or any combination of Examples 1-24 can optionally be configured such that all elements or options recited are available to use or select from.

Each of the non-limiting examples can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read-only memories (ROMs), or the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the aspects. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following aspects are hereby incorporated into the Detailed Description as examples or implementations, with each aspect standing on its own as a separate implementation, and it is contemplated that such implementations can be combined with each other in various combinations or permutations.

1. A boat comprising:
a boat frame including a boat deck;
an arch coupled to the boat frame, wherein the arch includes:
a first socket, and
a second socket;
a first speaker installed in the first socket, wherein the first speaker in the first socket is directed to a first area associated with the boat and the first speaker is configured to provide directional audio to the first area; and
a second speaker installed in the second socket, wherein the second speaker in the second socket is directed to a second area associated with the boat and the second speaker is configured to provide directional audio to the second area.

2. The boat of claim 1, wherein the arch is a unitary structure.

3. The boat of claim 2, wherein the unitary structure is comprised of carbon fiber.

4. The boat of claim 1, further comprising:
an audio control system to control the first speaker and the second speaker.

5. The boat of claim 4, further comprising:
a first wiring harness connecting the first speaker to the audio control system; and
a second wiring harness connecting the second speaker to the audio control system;
wherein the first wiring harness and the second wiring harness are provided inside the arch.

6. The boat of claim 1, wherein the boat is a pontoon boat.

7. The boat of claim 1, wherein the first speaker comprises a first sound bar and the second speaker comprises a second sound bar.

8. The boat of claim 1, wherein the first speaker is flush with the arch.

9. An arch for a boat, comprising:
a first end portion configured for coupling with a boat frame;
a second end portion configured for coupling with the boat frame;
an arch member extending between the first end portion and the second end portion having an arch profile, wherein the arch member includes a first socket and a second socket;
a first speaker installed in the first socket, wherein the first speaker in the first socket is directed to a first area associated with the boat and the first speaker is configured to provide directional audio to the first area; and
a second speaker installed in the second socket, wherein the second speaker in the second socket is directed to a second area associated with the boat and the second speaker is configured to provide directional audio to the second area.

10. The arch of claim 9, wherein the arch is a unitary structure.

11. The arch of claim 10, wherein the unitary structure is comprised of carbon fiber.

12. The arch of claim 9, wherein the first speaker comprises a first sound bar and the second speaker comprises a second sound bar.

13. The arch of claim 9, wherein:
the first speaker is positioned to face a bow of the boat to provide directional audio to a bow area; and
the second speaker is positioned to face an aft of the boat to provide directional audio to an aft area.

14. The arch of claim 9, further comprising:
a first wiring harness for connecting the first speaker to an audio control system; and
a second wiring harness for connecting the second speaker to the audio control system;
wherein the first wiring harness and the second wiring harness are provided inside the arch.

15. The arch of claim 9, wherein the first speaker is flush with the arch profile.

16. A boat comprising:
a boat frame including a boat deck;
an arch coupled to the boat frame; and
a plurality of speakers integrated within the arch to provide directional audio to a plurality of different areas associated with the boat.

17. The boat of claim 16, wherein the arch is a unitary structure.

18. The boat of claim 17, wherein the arch comprises one or more sockets for insertion of the plurality of speakers.

19. The boat of claim 16, further comprising:
an audio control system to control the plurality of speakers.

20. The boat of claim 19, further comprising:
one or more wiring harnesses connecting the plurality of speakers to the audio control system, wherein the one or more wiring harnesses are provided inside the arch.
